(19) United States
(12) Patent Application Publication
(10) Pub. No.: US 2025/0070463 A1
(43) Pub. Date: Feb. 27, 2025

(54) RADIATING ELEMENTS

(71) Applicant: Huawei Technologies Co., Ltd., Shenzhen (CN)

(72) Inventors: Ignacio Gonzalez, Munich (DE); Fabrizio Gentili, Munich (DE); Grzegorz Wolosinski, Munich (DE); Bruno Biscontini, Munich (DE)

(21) Appl. No.: 18/941,734

(22) Filed: Nov. 8, 2024

Related U.S. Application Data
(63) Continuation of application No. PCT/CN2022/092046, filed on May 10, 2022.

(51) Int. Cl. H01Q 3/36; H01Q 9/04; H01Q 9/16

(52) U.S. Cl. CPC H01Q 3/36; H01Q 9/0414; H01Q 9/16

(57) ABSTRACT

A radiating element comprises a first radiating structure disposed in spaced relation from a ground plane, a second radiating structure disposed in spaced relation from the first radiating structure, and a passive structure disposed between the first radiating structure and the second radiating structure configured to introduce a selected phase delay to a propagated field between the first radiating structure and the second radiating

### CROSS-REFERENCE TO RELATED APPLICATIONS

This application is a continuation of International Application No. PCT/CN2022/092046, filed on May 10, 2022, the disclosure of which is hereby incorporated by reference in its entirety.

### TECHNICAL FIELD

The present disclosure relates, in general, to radiating elements for use in antenna structures. Aspects of the disclosure relate to modification of phase relationships between layers of a radiating element.

### BACKGROUND

Meeting the demands of new generation mobile communications involves the upgrade of networks. For example, legacy antenna arrays can be upgraded to take advantage of the benefits that multiple-input and multiple-output (MIMO) antennas provide. In fact, massive MIMO (mMIMO), where a high number of antennas can be used, provides all of the benefits of conventional MIMO, but on a much greater scale.

However, many antenna site upgrades are hindered by the requirement to adhere to local regulations in terms of antenna dimension and so on. That is, the dimensions of new antennas are generally required to be comparable to legacy products. Furthermore, to be able to maintain the mechanical support structures, the wind load of the new antennas should be equivalent to the previous ones. These factors lead to strict limitations in, e.g., the width of the antenna.

The directivity of an antenna is limited by its aperture, and therefore, by the antenna width. This effect becomes critical when several arrays are placed inside the same enclosure, as in mMIMO for example. As a results, antenna arrays placed in a small reflector usually exhibit a broad horizontal beam width. This can result in a limited bandwidth, and problems with directivity of a radiated beam.

In order to overcome some of these drawbacks, current approaches implement radiating elements for an antenna array in the form of dual layer dipoles, in which a pair of radiating elements are positioned in a normal direction with respect to the antenna reflector. Typically, the pair of radiating elements are fed and radiate at the same frequencies as one another. However, a supplied signal can be subject to a phase shift that is applied such that each radiating element is fed with a difference of phase (alpha). The amplitude relation between the radiating elements can be used as a degree of freedom.

The provision of a phase shift in a signal supplied to the radiating elements results in an increase in the directivity of the combined antenna element which allows either a miniaturization of the antenna reflector or an increase the in coverage and signal-to-interference-plus-noise ratio (SINR) provided by the antenna system. The associated degrees of freedom (phase and amplitude distribution between the radiating elements) can also be used to improve the front to back and cross polar discrimination of the combined antenna element.

As fields propagate from the radiating elements, constructive and destructive superposition can be generated by controlling the phase of the radiated and impinging fields on each of the layers by, e.g., modifying the relative position of the radiating elements. For the fields to be added constructively, the phase (alpha) radiated from the first layer (closest to the ground plane) has to be selected carefully and depends on the frequency and distance to the second layer, and is therefore difficult to implement in practice. Furthermore, stacked radiators can have very different input impedances, the combination of which can result in a combined radiator which is very hard to match for a specific band width and phase difference (alpha). This is especially relevant when the phase introduced between the radiators is desired to be large in order to maximize the antenna directivity as the impedances seen from the feeding point can become more distinct.

### SUMMARY

An objective of the present disclosure is to provide an increase in impedance bandwidth for a specified directivity of the combination of layers of a multilayer antenna structure.

The foregoing and other objectives are achieved by the features of the independent claims.

Further implementation forms are apparent from the dependent claims, the description and the Figures.

A first aspect of the present disclosure provides a radiating element, comprising a first radiating structure disposed in spaced relation from a ground plane, a second radiating structure disposed in spaced relation from the first radiating structure, and a passive structure disposed between the first radiating structure and the second radiating structure configured to introduce a selected phase delay to a propagated field between the first radiating structure and the second radiating structure.

By, for example, increasing the phase difference between layers of a radiating element, an increase in directivity for a specified impedance bandwidth can be provided. For example, a difference in phase between the first and second layers can be augmented by an additional phase difference introduced by the passive structure.

In an implementation of the first aspect, the passive structure can comprise at least one metasurface. The passive structure can comprises multiple stacked metasurfaces. The passive structure can comprises a monolithic block of material of high relative permittivity. The passive structure can comprise a metamaterial structure.

In an example, the radiating element can further comprise at least one port configured to supply a feed signal to the first radiating structure and/or the second radiating structure. At least one port configured to receive a phase shifted signal can be provided. A phase shifter configured to modify a phase of the feed signal for at least one of the first radiating structure and the second radiating structure can be provided. An amplifier configured to modify an amplitude of the signal for at least one of the first radiating structure and the second radiating structure can be provided. At least one of the first radiating structure and the second radiating structure can comprise a dipole. At least one of the first radiating structure and the second radiating structure can be dual polarized. At least one of the first radiating structure and the second radiating structure can be planar structures.

A second aspect of the present disclosure provides an antenna array, comprising multiple radiating elements as provided according to the first aspect. The multiple radiating elements can form a massive multiple-input and multiple-output, mMIMO, antenna array.

A third aspect of the present disclosure provides a method for introducing a phase delay to a propagated field between a first radiating structure and a second radiating structure of a radiating element, the method comprising providing a passive structure disposed between the first radiating structure and the second radiating structure, wherein the passive structure is selected to introduce a selected first phase delay to the propagated field.

These and other aspects of the invention will be apparent from the embodiment(s) described below.

### BRIEF DESCRIPTION OF THE DRAWINGS

In order that the present invention may be more readily understood, embodiments of the invention will now be described, by way of example, with reference to the accompanying drawings, in which:

FIG. 1 is a schematic representation of a radiating element according to an example;

FIG. 2 is a schematic representation of a passive structure according to an example;

FIG. 3 is a schematic representation of an antenna array according to example; and

FIG. 4 is a schematic representation of a method for introducing a phase delay to a propagated field between a first radiating structure and a second radiating structure of a radiating element according to an example.

### DETAILED DESCRIPTION OF ILLUSTRATIVE EMBODIMENTS

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

According to an example, there is provided a dual layer dipole structure comprising a pair of radiating elements. A passive structure disposed between the radiating elements adds an arbitrary phase change (beta) in the propagated field from the bottom layer to the top layer of the combined dipole. The so introduced phase change (beta) can complement a defined phase change (alpha) to either increase the total phase or to decrease the required amount of alpha. This results in an increase in the resulting impedance bandwidth for a specified directivity of the combination of layers of the dipole by leveraging the change in mutual impedance and the reduction of alpha. There is an increase in directivity for a specified impedance bandwidth by way of an increase in the phase difference between the layers, as result of, e.g., augmenting the phase difference alpha by an amount beta.

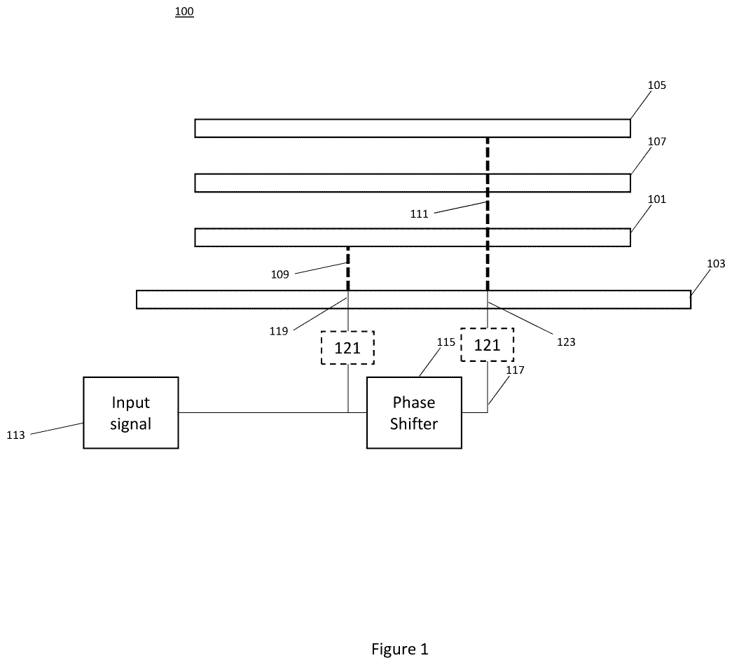

FIG. 1 is a schematic representation of a radiating element according to an example. In the example of FIG. 1 the radiating element 100 comprises a first radiating structure 101 disposed in spaced relation from a ground plane 103, and a second radiating structure 105 disposed in spaced relation from the first radiating structure 101. A passive structure 107 is disposed between the first radiating structure 101 and the second radiating structure 105. In an example, the passive structure 107 is configured to introduce a selected phase delay (beta) to a propagated field between the first radiating structure 101 and the second radiating structure 105.

Feed lines 109, 111 provide respective feed signals to the first radiating element 101 and the second radiating element 105. In an example, a feed signal 109 provided to the first radiating element 101 is an input signal 113 at a given frequency and phase. A phase shifter 115 can modify the phase of the input signal 113 whereby to provide a phase shifted signal 117 to the second radiating element 105. The difference in phase between the phase of the input signal 113 and the signal 117 is alpha. Put another way, the phase shifter 115 can introduce a phase shift alpha to the feed signal 111.

According to an example, the passive structure 107 introduces a phase delay beta in a propagated field from the first radiating element 101 to the second radiating element 105. In the example of figure, the phase change (beta) introduced by way of the passive structure 107 complements the defined phase change (alpha) introduced by the phase shifter 115. Accordingly, the total phase (alpha+beta) can be increased, the required amount of phase change alpha can be decreased.

According to an example, the passive structure 107 can comprise a metasurface. A metasurface according to an example can comprise a two-dimensional periodic array of scattering elements in the form of, e.g., a conductive pattern on the surface of a, e.g., dielectric substrate, where the dimensions and periods of the individual elements that make up the conductive pattern are small compared to the operating wavelength of the radiating element. The passive structure 107 can therefore comprise a planar surface comprising subwavelength metallic (or dielectric) elements. In an example, the structure 107 is passive because its properties cannot be tuned post-fabrication. The passive structure 107 alters the phase of a propagated electromagnetic field from the first radiating element 101 to the second radiating element 105.

According to an example, passive structure 107 can comprise one or more metasurfaces. A metasurface can be used to control the spatial phase of an electric field passing through it. Accordingly, the phase of a propagated field from the first radiating element 101 can be altered as it passes through the passive structure 107 without reflecting power.

In the example of FIG. 1, at least one port 119 is provided and so configured to supply the input signal 113 to the first radiating structure 101 in the form of feed signal 109. In some examples, the port 119 can be used to supply the input signal 113 to the second radiating structure 105. A second port 123 can be provided to and so configured to supply the phase shifted signal 117 to the second radiating structure 105 in the form of feed signal 111. In some examples, an amplifier 121 can be provided to modify an amplitude of the input signal 113 for at least one of the first radiating structure 101 and the second radiating structure 105.

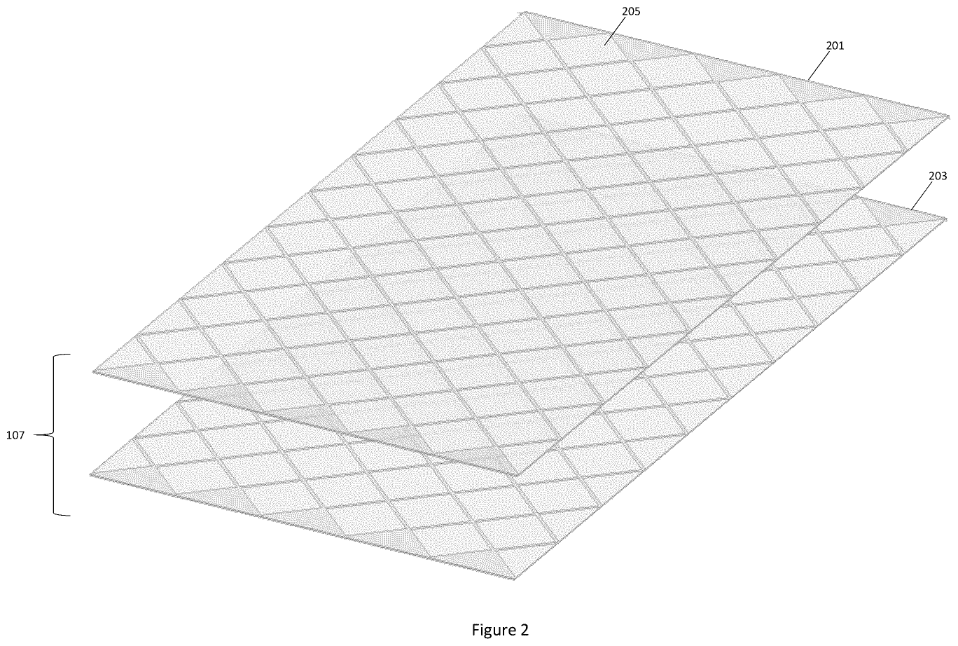

FIG. 2 is a schematic representation of a passive structure 107 according to an example. In the example of FIG. 2, a two layer passive structure 107 is depicted. Each layer 201, 203 defines a metasurface in the example of FIG. 2. Layers 201 and 203 comprise substrates upon which elements 205 are disposed or otherwise provided. Elements 205 can be in the form of, e.g., metal patches, which are depicted in a regular array in FIG. 2. Elements 205 may be shaped or profiled in any number of different ways, and the example of FIG. 2 is not intended to be limiting. Each layer 201, 203 may comprise a monolithic block of material of high relative permittivity such as a dielectric material for example. In an example, each layer 201, 203 will be as thin as possible, and as low loss as possible. Layers 201 and 203 can be separated from one another using, e.g., a foam material, such a foam material with a very low dielectric constant, or air.

According to an example, at least one of the first radiating structure 101 and the second radiating structure 105 comprises a dipole. At least one of the first radiating structure 101 and the second radiating structure 105 can be dual polarized.

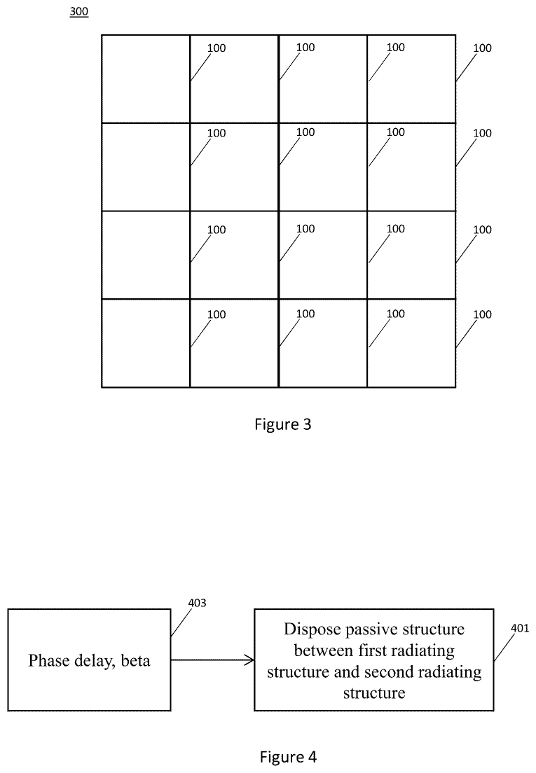

FIG. 3 is a schematic representation of an antenna array according to example. In the example of FIG. 2, the antenna array 300 comprises multiple radiating elements 100. The radiating elements 100 are arranged in a tiled configuration as part of, e.g., a mMIMO antenna array. Although not depicted in FIG. 3, each radiating element 100 may be spaced from adjacent radiating elements of the array 300.

FIG. 4 is a schematic representation of a method for introducing a phase delay to a propagated field between a first radiating structure and a second radiating structure of a radiating element according to an example. In block 401, a passive structure 107 is disposed between the first radiating structure 101 and the second radiating structure 105. According to an example, the passive structure 107 is selected to introduce a selected first phase delay 401 (beta) to the propagated field.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

What is claimed is:

1. A radiating element, comprising:
a first radiating structure disposed in spaced relation from a ground plane;
a second radiating structure disposed in spaced relation from the first radiating structure; and
a passive structure disposed between the first radiating structure and the second radiating structure, configured to introduce a phase delay to a propagated field between the first radiating structure and the second radiating structure.

2. The radiating element of claim 1, wherein the passive structure comprises at least one metasurface.

3. The radiating element of claim 1, wherein the passive structure comprises multiple stacked metasurfaces.

4. The radiating element of claim 1, wherein the passive structure comprises a monolithic block of material of high relative permittivity.

5. The radiating element of claim 1, wherein the passive structure comprises a metamaterial structure.

6. The radiating element of claim 1, further comprising at least one port configured to supply a feed signal to the first radiating structure or the second radiating structure.

7. The radiating element of claim 1, further comprising at least one port configured to receive a phase shifted signal.

8. The radiating element of claim 6, further comprising a phase shifter configured to modify a phase of the feed signal for at least one of the first radiating structure and the second radiating structure.

9. The radiating element of claim 6, further comprising an amplifier configured to modify an amplitude of the feed signal for at least one of the first radiating structure and the second radiating structure.

10. The radiating element of claim 1, wherein at least one of the first radiating structure and the second radiating structure comprises a dipole.

11. The radiating element of claim 1, wherein at least one of the first radiating structure and the second radiating structure are dual polarized.

12. The radiating element of claim 1, wherein at least one of the first radiating structure and the second radiating structure are planar structures.

13. An antenna array, comprising a plurality of radiating elements, each of the plurality of radiating elements comprising:
a first radiating structure disposed in spaced relation from a ground plane;
a second radiating structure disposed in spaced relation from the first radiating structure; and
a passive structure disposed between the first radiating structure and the second radiating structure, configured to introduce a phase delay to a propagated field between the first radiating structure and the second radiating structure.

14. The antenna array of claim 13, wherein the plurality of radiating elements form a massive multiple-input and multiple-output, mMIMO, antenna array.

15. The antenna array of claim 13, wherein each of the plurality of radiating elements further comprises at least one port configured to supply a feed signal to the first radiating structure or the second radiating structure.

16. The antenna array of claim 13, wherein each of the plurality of radiating elements further comprises at least one port configured to receive a phase shifted signal.

17. The antenna array of claim 13, wherein each of the plurality of radiating elements further comprises a phase shifter configured to modify a phase of a feed signal for at least one of the first radiating structure and the second radiating structure.

18. The antenna array of claim 13, wherein each of the plurality of radiating elements further comprises an amplifier configured to modify an amplitude of a feed signal for at least one of the first radiating structure and the second radiating structure.

19. The antenna array of claim 13, wherein for each of the plurality of radiating elements at least one of the first radiating structure and the second radiating structure comprises a dipole.

20. A method, comprising:
disposing a passive structure between a first radiating structure and a second radiating structure of a radiating element, wherein the passive structure introduces a first phase delay to a propagated field between the first radiating structure and the second radiating structure of the radiating element.
